(19) United States
(12) Patent Application Publication
(10) Pub. No.: US 2025/0099939 A1
(43) Pub. Date: Mar. 27, 2025

(54) FISCHER TROPSCH REACTOR WITH NOVEL HEAT TRANSFER MECHANISM AND METHODS OF SYNGAS REFORMING

(71) Applicant: Oxeon Energy, LLC, North Salt Lake, UT (US)

(72) Inventors: Joseph Hartvigsen, Kaysville, UT (US); S Elangovan, South Jordan, UT (US); Michelle Hollist, Salt Lake City, UT (US)

(21) Appl. No.: 18/892,175

(22) Filed: Sep. 20, 2024

Related U.S. Application Data
(60) Provisional application No. 63/539,812, filed on Sep. 21, 2023.

(51) Int. Cl. B01J 19/24; B01J 8/06; C10G 2/00

(52) U.S. Cl. CPC B01J 19/2415; B01J 8/067; B01J 19/2485; C10G 2/341; B01J 2219/2419

(57) ABSTRACT

A heat transfer insert configured to fin within FT reactor is disclosed. The insert includes a fin structure that defines a longitudinal void along a longitudinal central axis of the fin structure or insert. The fin structure defines a plurality of catalytic reaction zones and a space configured to receive a thermocouple. The central longitudinal axis of the insert, which is also the centerline of the longitudinal void, is not colinear with the longitudinal axis of the thermocouple space. An FT reactor may include the heat transfer insert and an FT system may include one or more FT reactors. Configurations herein allow for catalytic reaction temperatures to be measured within the reactor at a place other than the centerline of the FT reactor.

### CROSS-REFERENCE TO RELATED APPLICATIONS

This application claims the priority benefit of U.S. Provisional Application No. 63/539,812 filed on Sep. 21, 2023.

### TECHNICAL FIELD

The present disclosure relates to Fischer Tropsch reactors and methods for more efficiently performing Fischer Tropsch processing of a gas feedstock. More specifically, the present disclosure relates to an FT reactor heat transfer insert with improved catalyst reaction and temperature control features for more efficient Fischer Tropsch processing outputs.

### BACKGROUND

A Fischer Tropsch (“FT”) process, which is sometimes called FT synthesis, is a chemical reaction used to produce liquid hydrocarbons from gas feedstocks that contain hydrogen and carbon monoxide. Feedstocks containing hydrogen and carbon monoxide are often referred to as synthesis gas, or “syngas.” The FT process is typically a surface catalyzed carbon polymerization process that largely produces straight chain hydrocarbons that range from C1 to greater than C100 hydrocarbons. The hydrocarbon outputs from an FT process or reaction generally follow an Anderson-Schulz-Flory (“ASF”) distribution. FT processes generally produce a mixture of liquid and gaseous hydrocarbons molecules. For many applications, it is desirable to form more liquid hydrocarbons (such as octane, hexane, and other hydrocarbons with carbon numbers greater than 5) than it is to produce gaseous products (such as methane, ethane, etc.). Where FT reactors are used as part of a gas-to-liquid process, which starts with gas, many users desire the FT reactor to produce more liquid than gas.

As mentioned, the reactions that occur in FT reactors are often catalyst-based and are highly exothermic. If the produced heat is not removed as part of the reaction conditions, the reaction can “run away,” and the resulting increase of heat within the reactor causes the process to produce more gaseous hydrocarbon molecules and less liquid hydrocarbon molecules, which may be undesirable. Conversely, if there is not enough heat in the process, then the catalyst is underutilized and the process becomes inefficient, and therefore more costly when trying to make liquid hydrocarbons.

One attempt to deal with the exothermic reactions in FT processes has been to use an insert within the FT reactor tube that serves to transfer heat from the interior of the tube to the outside annular wall of the tube. The insert serves as a structure to compartmentalize the interior of the FT reactor. The compartments can be filled with catalyst to create a fixed bed reactor through which gas can flow and be transformed into desired hydrocarbon liquids. The heat of reacting catalyst transfers from the compartments or zones through the insert and away from the reaction. However, there are many problems with existing heat transfer inserts as applied to FT processes.

One problem with some FT reactor inserts is that they are intricately designed with fins or structures that are partially curved, have undulating thicknesses, have elaborate cross-sectional designs, or have structural lengths that are longer than the radius of the tube. The organic looking fin designs might have theoretically acceptable heat transfer properties, but they would be so difficult and expensive to manufacture, that these heat transfer inserts are impractical. The most efficient least-expensive ways to make FT heat transfer inserts is by extrusion. The intricately designed inserts simply do not lend themselves to extrusion.

Another problem with prior art FT reactor inserts is that in order to be effective, there must be a place to house a heat sensor; typically, a thermocouple. Prior art FT reactor heat inserts create an annular space in the center of the insert, where the thermocouple is colinear with a central longitudinal axis of the insert, and the insert structure radiates out from the thermocouple to the outer wall of the FT reactor. These attempts and create better FT reaction temperatures may be less expensive to make than other prior art attempts because they have substantially symmetrical cross sections that make for simpler extrusion molds. However, inserts that allow for center axis thermocouple positioning do not provide the best measurement of the heat of reaction across the fixed catalyst bed. Accordingly, these prior art inserts do not allow for optimal FT outputs because the reaction temperature cannot be optimally controlled. The result is waste in terms of underutilized catalyst, and/or undesirable gaseous outputs.

Another problem with prior art heat transfer inserts in FT processes and systems is the catalyst zones that they create with their structure. Except for the space reserved for a thermocouple, is any, these catalyst zones as centrally located and proximate a longitudinal centerline of the insert as possible. Heat charts for these prior art inserts reveal that these central catalyst zones create the greatest reaction temperatures and may increase the chance of the overall reaction bed temperature running away or getting out of control. These prior art heat transfer inserts also create a wide distribution of reaction temperatures along the cross-section of the insert making it difficult to control the catalytic reaction across the whole fixed catalyst bed. Furthermore, uneven temperatures across the catalyst bed can be detrimental to the production of higher value liquid hydrocarbon FT outputs.

Additionally, prior art FT reactor inserts do not allow for efficient pre-heating of the feedstock gas which makes the catalytic reaction more. These inserts and corresponding FT reactors, systems and methods require a separate preheating structure and step that is outside the reactor.

Accordingly, there is a need in the art for a better, more efficient, more versatile heat transfer insert and corresponding FT reactors, systems, and process methods. Such a device and method for using same are disclosed and claimed herein.

### SUMMARY

Fischer Tropsch (FT) processing is a method for the production of various hydrocarbons from the input of synthesis gas. It is typically a surface catalyzed carbon polymerization process that largely produces straight chain hydrocarbons that range from C₁ to greater than C₁₀₀ hydrocarbon products. In certain embodiments, the hydrocarbon products generally follow a distribution called the ASF (Anderson-Schultz-Flory) distribution defined by the chain growth probability factor (“α”) that is a strong function of temperature. Maintaining the catalyst bed at an even temperature is important since higher bed temperatures tend to favor the formation of more of the gaseous (i.e. lower value) products while lower temperatures tend to favor production of waxes that are not easily transported by pipeline or directly usable as fuel. Accordingly, one purpose of certain embodiments of the present invention is to create an FT reactor that more effectively allows for the measurement and control of the temperature of the catalyst bed within the reactor to improve yields in the liquid and wax range of FT products, while also helping to prevent catalyst damage.

In certain FT process embodiments, the ASF chain growth probability factor (α) decreases with the increase in catalyst temperature. Thus, by way of nonlimiting example, were the catalyst or reaction temperature to increase by about a degree, the probability factor (α) may decrease by about 0.004. In this example, this would mean that a 15° C. variation in local bed temperature could mean a 0.06 shift in alpha which would have a major impact on the product distribution. By way of further nonlimiting example, if the optimal alpha value for a desired liquid product was about 0.85, portions of the reactor 15° C. cooler would have an alpha of 0.91 and make too much wax while portions of the reactor 15° C. hotter would make less liquid and too much gas as product. Accordingly, it is desirable to find apparatuses, systems, and methods that will help control the temperature along the entire length and in radial direction of the FT reactor, and thus, the alpha value, to provide consistent results.

Embodiments of a heat transfer insert, an FT reactor and system, and FT processes are described herein to overcome problems of the prior art. Embodiments may include a fin structure configured to fit within a substantially tubular container. The fin structure defines a central longitudinal void along a central axis of the fin structure. In one embodiment, the fin structure includes a plurality of fins extending outwardly from the central longitudinal void. The plurality of fins define a plurality of catalytic reaction zones along a length of the fin structure. The plurality of fins are configured to transfer heat from an interior of the fin structure to an exterior of the fin structure. In certain embodiments the fin structure may include secondary or tertiary fins that extend from a first or primary set of fins. These fins may extend into catalytic reaction zones defined by primary fins. In certain embodiments, the thickness of one or more of the fins is substantially uniform.

In one embodiment, the fin structure defines a thermocouple space extending substantially along the length of the fin structure. The thermocouple space is configured to receive a thermocouple. The central axis of the thermocouple space is not colinear with the central axis of the fin structure. In other words, the thermocouple is offset from the longitudinal center of the insert, and thus, the longitudinal center of any FT reactor in which the insert resides. In certain embodiments, the insert is configured to fit within a tube and the thermocouple space and central void are substantially columnar along a length of the fin structure. Accordingly, in this embodiment, a right-angle cross-sectional view of the fin structure shows the thermocouple space and central void space as circles.

In one embodiment, the thermocouple space is at least partially contiguous with the central void in a cross section of the fin structure. Accordingly, in this embodiment, the longitudinal axis of the thermocouple space and any thermocouple therein may be proximate the longitudinal axis of the fin structure and its central void, albeit not colinear with it. In another embodiment the thermocouple space is not contiguous with the central void. In this embodiment the thermocouple space and any thermocouple may be positioned further away from the central void and center axis of the fin structure. In this embodiment, the thermocouple space is configured within the fin structure to allow a thermocouple to be positioned closer to an outer perimeter of the fin structure.

In other embodiments a cross section of the fin structure may show that the thermocouple space is 95% contiguous with the central void. In yet other embodiments, the thermocouple space is 90, 85, 80, 75, 70, 65, 60, 55, 50, 45, 40, 351, 309, 25, 20, 15, 10, 5, or 1% contiguous with the central void. Similarly, fin structure may be configured such that a cross section may include a thermocouple space that is positioned between the central void and an outer perimeter of the fin structure. These embodiments allow a thermocouple to be positioned anywhere within the fin structure other than the longitudinal center of the fin structure. This allows for a better fixed catalyst bed reaction temperature measurement to be taken with the insert is part of an FT reactor, system, or process.

Embodiments of FT reactors containing embodiments of heat transfer inserts are described herein. Embodiments of FT systems containing embodiments of FT reactors are described herein. Additionally, embodiments of FT methods or processes utilizing FT apparatuses are described herein.

### BRIEF DESCRIPTION OF THE DRAWINGS

FIG. 1 shows a perspective view of an embodiment of a heat transfer insert that may be used as part of an FT reactor;

FIG. 2 shows a right cross-sectional view of FIG. 1 along line A-A of FIG. 1;

FIG. 3 shows a closeup view of Section B of FIG. 2;

FIGS. 4A-D shows a right cross a thermocouple space at various offsets relative to the central void;

FIG. 5 shows a right cross-sectional view of another embodiment of a heat transfer insert where the thermocouple space does not overlap the central void;

FIG. 6A shows an exploded right cross-sectional view of another embodiment of an insert that may be used as part of an FT reactor;

FIG. 6B is a cross-section view along line A-A of FIG. 6A;

FIG. 7 is a schematic view of an FT Reactor system that includes an FT Reactor using embodiments of a heat transfer insert; and

FIG. 8 is a flow chart showing an embodiment of a process for converting a gas feedstock into a liquid hydrocarbon using an embodiment of a FT system described herein.

### DETAILED DESCRIPTION

The present embodiments of the present invention will be best understood by reference to the drawings, wherein like parts are designated by like numerals throughout. It will be readily understood that the components of the present invention, as generally described and illustrated in the Figures herein, could be arranged and designed in a wide variety of different configurations. Thus, the following more detailed description of the embodiments of the methods and reactor components and systems, as represented in the Figures, is not intended to limit the scope of the invention, as claimed, but is merely representative of present embodiments of the invention. Accordingly, various substitutions, modifications, additions rearrangements, or combinations thereof are within the scope of this disclosure.

In accordance with common practice, the various features illustrated in the drawings may not be drawn to scale. The illustrations presented herein are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Additionally, various aspects or features may be presented in terms of apparatuses, devices, systems, and method steps, and each may include a number of sub parts, components, modules, and the like. It is to be understood and appreciated that the various apparatuses, devices, systems, and/or methods may include additional components or parts that are not shown and/or may not include all of the components or sub parts that are discussed in connection with the figures. Furthermore, all or a portion of any embodiment, feature, or functionality disclosed herein may be utilized with all or a portion of any other embodiment, unless stated otherwise. Accordingly, all of the features of the invention may not be described in conjunction with a particular embodiment described herein so as to avoid repetition, but all of the features described in conjunction with any one embodiment should be read to apply to all embodiments described herein.

In addition, it is noted that the embodiments may be described in terms of a process that is depicted as method steps, a flowchart, a flow diagram, a schematic diagram, a block diagram, a function, a procedure, a subroutine, a subprogram, and the like. Although the process may describe operational steps in a particular sequence, it is to be understood that some or all of such steps may be performed in a different sequence. In certain circumstances, the steps are performed concurrently with other steps.

The terms used in describing the various embodiments of the disclosure are for the purpose of describing particular embodiments and are not intended to limit the disclosure. As used herein, the singular forms are intended to include the plural forms as well, unless the context clearly indicates otherwise. All of the terms used herein, including technical or scientific terms have the same meanings as those generally understood by an ordinary skilled person in the related art unless they are defined otherwise. Terms defined in this disclosure should not be interpreted as excluding the embodiments of the disclosure. Additional term usage is described below to assist the reader in understanding the disclosure.

The terms “have,” “may have,” “include,” and “may include” as used herein indicate the presence of corresponding features (for example, elements such as numerical values, functions, operations, or parts), and do not preclude the presence of additional features.

The word “exemplary” is used herein to mean “serving as an example or illustration.” Any aspect or design described herein as “exemplary” is not necessarily to be construed as preferred or advantageous over other aspects or designs.

The terms “A or B,” “at least one of A and B,” “one or more of A and B”, or “A and/or B” as used herein include all possible combinations of items enumerated with them. For example, use of these terms, with A and B representing different items, means: (1) including at least one A; (2) including at least one B; or (3) including both at least one A and at least one B. In addition, the articles “a” and “an” as used herein should generally be construed to mean “one or more” unless specified otherwise or clear from the context to be directed to a singular form.

Terms such as “first,” “second,” and so forth are used herein to distinguish one component from another without limiting the components and do not necessarily reflect importance, quantity, or an order of use. For example, a first user device and a second user device may indicate different user devices regardless of the order or importance. Furthermore, a reference to first and second elements does not mean that only two elements may be employed there or that the first element must precede the second element in some manner. Also, unless stated otherwise a set of elements may comprise one or more elements.

It will be understood that, when two or more elements are described as being “coupled”, “operatively coupled”, “in communication”, or “in operable communication” with or to each other, the connection or communication may be direct, or there may be an intervening element between the two or more elements. To the contrary, it will be understood that when two or more elements are described as being “directly” coupled with or to another element or in “direct communication” with or to another element, there is no intervening element between the first two or more elements.

Furthermore, “connections” or “communication” between elements may be, without limitation, wired, wireless, electrical, mechanical, optical, chemical, electrochemical, comparative, by sensing, or in any other way two or more elements interact, communicate, or acknowledge each other. It will further be appreciated that elements may be “connected” with or to each other, or in “communication” with or to each other by way of local or remote processes, local or remote devices or systems, distributed devices, or systems, or across local or area networks, telecommunication networks, the Internet, other data communication networks conforming to a variety of protocols, or combinations of any of these. Thus, by way of non-limiting example, units, components, modules, elements, devices, and the like may be “connected”, or “communicate” with each other locally or remotely by means of a coaxial cable, fiber optic cable, twisted pair, digital subscriber line (DSL), shared chipset or wireless technologies such as infrared, radio, and microwave.

The expression “configured to” as used herein may be used interchangeably with “suitable for,” “having the capacity to,” “designed to,” “adapted to,” “made to,” or “capable of” according to a context. The term “configured” does not necessarily mean “specifically designed to” in a hardware level. Instead, the expression “apparatus configured to . . . ” may mean that the apparatus is “capable of . . . ” along with other devices or parts in a certain context.

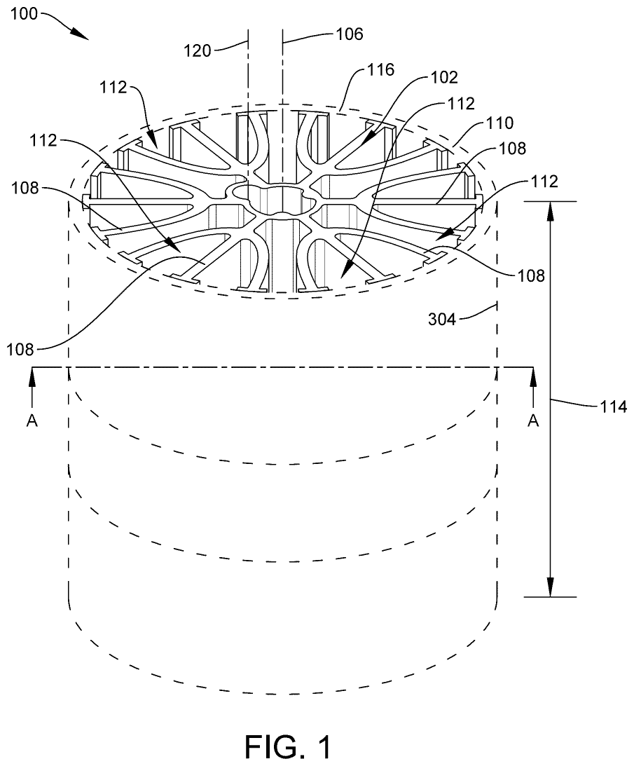

Turning now to FIG. 1, a heat transfer insert 100 may include a fin structure 102. The fin structure 102 may be configured to fit within a substantially tubular container (not shown). In one embodiment, the fin structure and/or insert may be used as part of a Fischer Tropsch reactor (not shown). The fin structure 102 may define a central longitudinal void 104 positioned at least partially along a central axis 106 of the fin structure 102. In one embodiment, the central longitudinal void 104 is configured to hold components of a Fischer Tropsch reactor (not shown) in which the insert 100 may reside.

The fin structure 102 includes a plurality of fins 108. The plurality of fins 108 may be configured to receive a catalyst or other exothermic reaction enhancers (not shown) when the insert is positioned within an enclosure 110 such as, by nonlimiting example, a tube, cylinder, are standard pipe. In one embodiment, the plurality of fins 108 are configured to define reaction zones 112 along a length 114 of the insert 100 when the insert 100 is part of a Fischer Tropsch Reactor, as will be discussed in further detail below. The plurality of fins 108 may extend from the central void 104 directly or indirectly to a perimeter 116 of the insert 100 along all or a portion of a length 114 of the fin structure 102 or insert 100.

In one embodiment, the fin structure 102 defines a thermocouple space 118 extending substantially along the length 114 of the fin structure, wherein the thermocouple space 118 is configured to receive a thermocouple (not shown). A thermocouple may be used to measure the temperature within the insert. By way of non-limiting example, when the insert is used as part of a Fischer Tropsch reactor, the thermocouple may measure the heat of a catalytic or other reaction happening within the perimeter 116 of the fin structure 102. The thermocouple space 118 may extend along some or all of the length 114 of the insert 100. The thermocouple space 118 may have a central axis 120. In one embodiment, the thermocouple space 118 is not colinear with the central axis 106. In one embodiment, the fin structure 102 is configured such that a thermocouple positioned at the center or centerline of the fin structure 102. In this configuration, the temperature of any reaction occurring within the insert is not measured at the middle or centerline 106 of the insert 100 or any Fischer Tropsch reactor in which the insert 100 may reside.

It will be appreciated by those of skill in the art that the enclosure, fin structure perimeter, central void perimeter, and/or thermocouple space, may be in a cross sectionally oval, square, or any other symmetrical or asymmetrical shape. The voids in the insert may run entirely through the insert or partially therethrough.

It will be appreciated that the insert 100 or fin structure 102 in some embodiments may include an enclosure or wrap around the fin structure, and that the terms “fin structure” and “insert” may be used synonymously herein throughout unless specifically stated otherwise. For ease of discussion, the fin structure 102 may be referred hereafter as the “insert.”

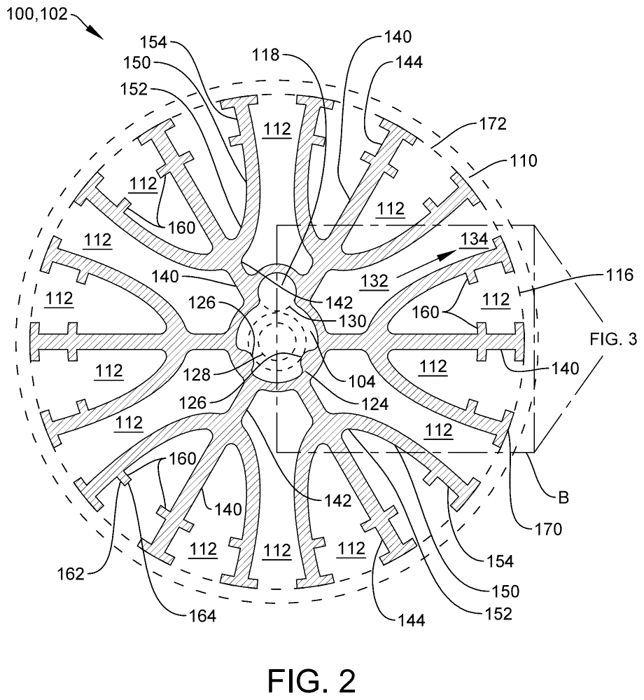

Turning now to FIG. 2, a cross section of the insert 100 of FIG. 1 is shown along right angle plane A-A. In one embodiment, the central longitudinal void 104 is substantially columnar as it extends longitudinally along some or all of the length 114 of the insert. Accordingly, in one embodiment, the central void 104, and the corresponding portion 124 of the fin structure 102 that defines the central void 104, may have a substantially circular cross-section.

In one embodiment, the insert 100 may include at least one positioning nub 126 extending into the central void 104. The positioning nub 126 may be configured to help position something (shown in dashed cross-section 128) within the central void 104. As will be discussed in greater detail below, a bayonet or tube 128 may be placed longitudinally along the centerline (see 106 in FIG. 1) of the insert 100. The positioning nub 126 may be configured to help position an inserted piece 128 in a substantially centered position within the central void 104 along all or a portion of the length 114 of the insert 100. In one embodiment, an outer perimeter 130 (shown in dashed lines) of a thermocouple (not shown) inserted within the thermocouple space 118 serves as a positioning nub 126. It will be appreciated by those of skill in the art that any surface, whether or not a part of the fin structure 102 or heat insert, the extends into the central void 104 may be a positioning nub 126.

The plurality of fins 112 may extend outwardly from the central void 104, or the corresponding portion 124 of the fin structure 102 that defines the central void 104, to an outer perimeter 116 of the insert 100. Accordingly, the fins 112 are configured to be able to transfer heat from a more central cross-sectional area 132 of the insert 100 to a less central cross-sectional area 134 of the insert 100. Indeed, the fins 112 are configured to remove or take out heat from an apparatus in which the insert 100 is positioned.

In one embodiment, the fins 108 of the insert 100 may include a first plurality of fins 108, 140 (FIX CLAIMS—PRIMARY SECONDARY ETC) having a first end 142 connected to the portion 124 of the fin structure 102 that defines the central void 104. In one embodiment, the first plurality of fins 108, 140 may include a second or distal end 144. The second or distal end 144 may be configured to engage the enclosure 110 (shown in dashed) in which the insert 100 may be inserted. In one embodiment, the insert 100 may include a second plurality of fins 108, 150 having a first end 152 attached or proximate one or more of the first plurality of fins. The second plurality of fins 108, 150 may include a second end 154 the extends away from the primary fin 140. In one embodiment, the second end 154 of the second plurality of fins 108, 150 may be configured to engage an enclosure 110 in which the insert 100 is positioned. In yet another embodiment, the insert 100 may include a third plurality of fins 160. The third plurality of fins 108, 160 may include a first end 162 attached or proximate one or more of the second plurality of fins 108, 160. The third plurality of fins 160 may include a second end 164 the extends away from the secondary fin 150. In one embodiment, the second end 164 of the third plurality of fins 108, 160 may be configured to engage an enclosure 110 in which the insert 100 is positioned. In the embodiment of FIG. 2, and end 162, 164 of the third plurality of 108, 160 fins does not engage the enclosure 100. In certain embodiments, ends of fins 140, 150, and 160 are configured to engage the enclosure 110 and may be configured with pads 170 to facilitate contact between the insert 100 and an inner surface 172 of the enclosure 110.

The plurality of fins 108 are configured to define a plurality of catalytic reaction zones 166 along a length 114 (see FIG. 1) of the fin structure 102. When exothermic reactions occur within one or more catalytic reaction zones 166 the fin structure 102 is configured to transfer heat from within the insert 102 to the exterior of the insert, and thus, out of a vessel or apparatus in which the insert may be positioned.

In one embodiment, the central longitudinal void 104 is configured to keep catalyst or reaction enhancing material out of the central longitudinal void 104 or cross-sectional center of the fin structure. In other words, in one embodiment, the fin structure is configured such that catalyst may be kept out of the longitudinal center of the insert 100 and any FT reactor wherein the insert 100 may be positioned. In this configuration, the central longitudinal void 104 does not serve as a reaction zone 166. It will be appreciated by those of skill in the art that the center of an insert 100 that is used to create longitudinal reaction zones for a catalytic FT reactor may be hotter at a center line of the reactor. Thus, having a configuration that reduces a catalytic reaction there will increase the control of the uniformity of the reaction heat across the whole of the reaction beds zones 166 created by the insert 100.

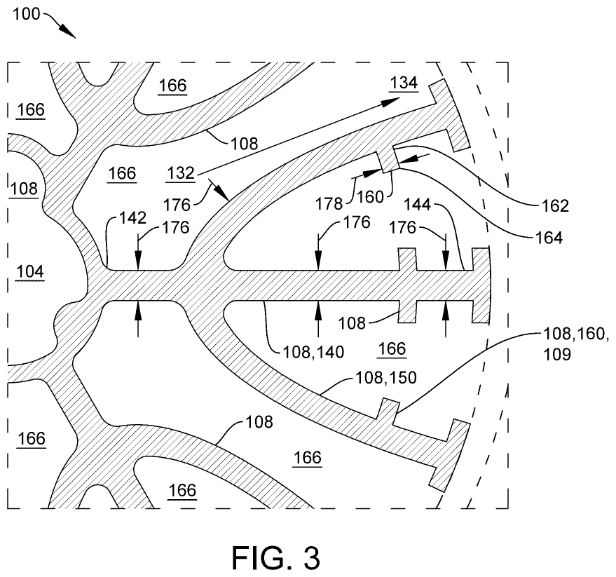

Turning now to FIG. 3, a section B of the cross-sectional view of FIG. 2 is shown having reaction zones 166 within which the heat of reaction which might occur. In this particular non-limiting example, hotter reaction temperatures may occur in various zone than others. It will be appreciated that certain catalysts (not shown) placed within certain insert 100 configurations may cause hot spots (not shown) within a Fischer Tropsch reactor containing the insert 100. Conversely, the central void, which contains no catalyst material, will be cooler than areas that are configured to define a reaction zone 166 and contain a reaction catalyst.

Fins 108 may be positioned adjacent to observed or calculated hot spots to remove the heat from the particular hotspot. For example, a tertiary fin 160, 109 may be positioned to penetrate into a reaction zone 166, and thus into a catalyst volume where a hot spot 168 may reside. This, fin 108, 160, 109 provides increased heat transfer material surface area adjacent to, or within, the hot spot 168, and thus a heat transfer path that will minimize or eliminate the hot spot 168. This in turn makes the overall temperature within any such Fischer Tropsch reactor more uniform, easier to control, and less likely to exceed desired reaction temperature ranges within a reaction zone 166 specifically and across a Fischer Tropsch reactor generally. Thus, in one embodiment, the fins 108 are configured to transfer heat from a more central cross-sectional area 132 of the insert 100 to a less central cross-sectional area 134 of the insert 100. In one embodiment, the insert 100 is made of a heat conductive metal. In another embodiment, the insert 100 is made of aluminum. In other embodiments, the fin structure 102 is configured for more efficient and less expensive extrusion.

It will be appreciated that extrusion requires tooling and the more complex the extrusion, the more expensive the tooling and the extrusion procedures. For example, while the elaborate shapes of fin structures might theoretically improve heat transfer in certain insert designs, the insert 100 might be weakened by having long and spindly fin branches that are far from the support of a thicker main branch or a core fin structure section. Indeed, a lack of fin thickness uniformity may not only be more costly to create, but it may be weaker as is goes from thicker portions to thinner portions.

In one embodiment, a cross-sectional thickness of at least one of the fins 108 or fin portions is substantially uniform between a first end (142, 152, 162) and a second end (144, 154, 164) of said one or more fins. For example, a primary fin 108, 140 may have a thickness 176 that is the same along a length of the fin 108, 140 between its first end 142 and its second end 144. A secondary or tertiary fin 108, 160 may have a thickness 178 that is the same along a length of the fin 108, 160 between its first end 162 and its second end 164. The thicknesses of various fins, 140, 150, 160, etc. need not be the same as each other. Indeed, in one embodiment, fins 108 or sets of fins may be uniformly thinner if they are further away from the center of the insert than those that may be closer to the center of the insert.

In one embodiment, at least some of the fins 108 of the insert include curves having tangents along the length of curve that do not cross the curve. In other words, at least some of the fins 108 do not undulate or have waves. In certain embodiments, the curves of the fins 108 may be simple open or closed curves. It will be appreciated that substantially uniform thickness and simple curve structures make for easier and cheaper and machine tooling for, and extrusion of, the insert 100. Similarly, fins 108 with long stem portions branching off from a fin may create leverage forces on that fin during extrusion. In one embodiment, fins 108 that extend from other fins 108 are shorter than the fins they extend from. For example, in one embodiment, a tertiary fin 160 may be shorter than the secondary fin 150 from which it extends. Similarly, a secondary fin 150 may be shorter than the primary fin 140 from which it extends. In one embodiment, the branching fin extending from a base fin is shorter than or equal to half the length of the base fin from which it extends. For example, a tertiary fin 160 may be less than or equal to half the length of the secondary fin 150 from which it extends. Similarly, a secondary fin 150 may be less than or equal to half the length of the primary fin 140 from which it extends.

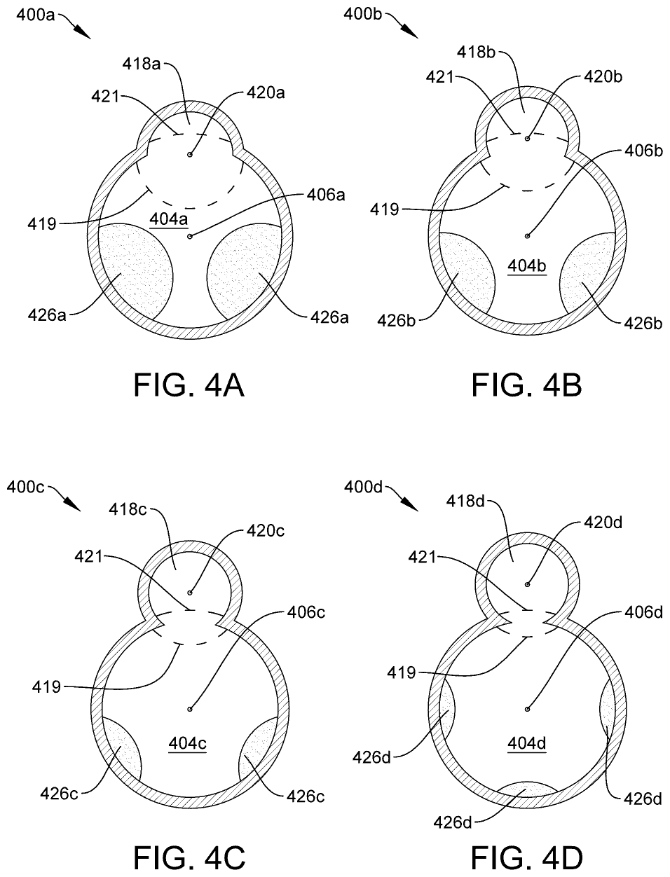

Turning now to FIGS. 4a-4d, other embodiments of an insert 400a-d having various configurations of a thermocouple space 418 a-d relative to a central longitudinal void (404 a-d) are shown. In the embodiments of FIGS. 4a-4d, the thermal couple space 418 a-d and the central void (404a-d) of the insert (400 a-d) are at least partially contiguous. In other words, the thermal couple space 418 a-d and the central void (404a-d) overlap as shown by the dashed lines 419 and 421 of FIGS. 4a-4d that represent the cross-sectional perimeters of the thermocouple space 418 and central void 404 respectively. Indeed, in these configurations, the central void (404 a-d) and the contiguous thermocouple space (418 a-d) may be said to be one oddly shaped space respectively. It will be appreciated that in certain embodiments the cross-sectional perimeters 419 and 421 of the thermocouple space and/or central void are the same as the cross-sectional outer diameter 419 and 421 of the thermocouple space and/or the central void respectively.

As mentioned above, the thermocouple spaces (418 a-d) are configured to hold a thermocouple (not shown). In certain embodiments, positioning nubs (426 a-d) are configured to match the cross-sectional shape of the amount of thermocouple that extends into the central void (404 a-d). In some embodiments, nubs (426 a-d) need not match each other or the cross-sectional shape of the amount of thermocouple that extends into the central void (404 a-d). Additionally, the number of nubs (426 a-d) within a particular insert (400 a-d) need not be the same. For example, the nubs (426 a-c) of inserts (400 a-c) respectively do not equal the number of nubs 426d of insert 400d.

In one embodiment, a center longitudinal axis 420a-d of the respective thermocouple spaces 418a-d are off center from the center longitudinal axis 406a-d of the respective central voids 404a-d (and consequently of the respective fin structures not shown) than or equal to 1%. In another embodiment, a center longitudinal axis 420a-d of the respective thermocouple spaces 418a-d are off center from the center longitudinal axis 406a-d of the respective central voids 404a-d (and consequently of the respective fin structures not shown) by less than or equal to 90%. The amount that the center longitudinal axis 420a-d of the respective thermocouple spaces 418a-d are off center from the center longitudinal axis 406a-d of the respective central voids 404a-d (and consequently of the respective fin structures not shown) may be referred to as the “offset.” In other embodiments, the cross-sectional perimeter 419 or outside diameter 419 of the thermocouple space 418a-d may overlap at least 1% of the cross-sectional perimeter 421 or outside diameter 421 of the central void 404a-d. In another embodiment, in other embodiments, the cross-sectional perimeter 419 or outside diameter 419 of the thermocouple space 418a-d may overlap less than 90% of the cross-sectional perimeter 421 or outside diameter 421 of the central void 404a-d. The amount of overlap of the cross-sectional perimeter 419 or outside diameter 419 of the thermocouple space 418a-d and the cross-sectional perimeter 419 or outside diameter 419 of the central longitudinal void 404a-d may also be referred to as the “offset.” In yet other embodiments, the offset may be about 10%, 20%, 30%, 40%, 50%, 60%, 70%, 80%, or 90%.

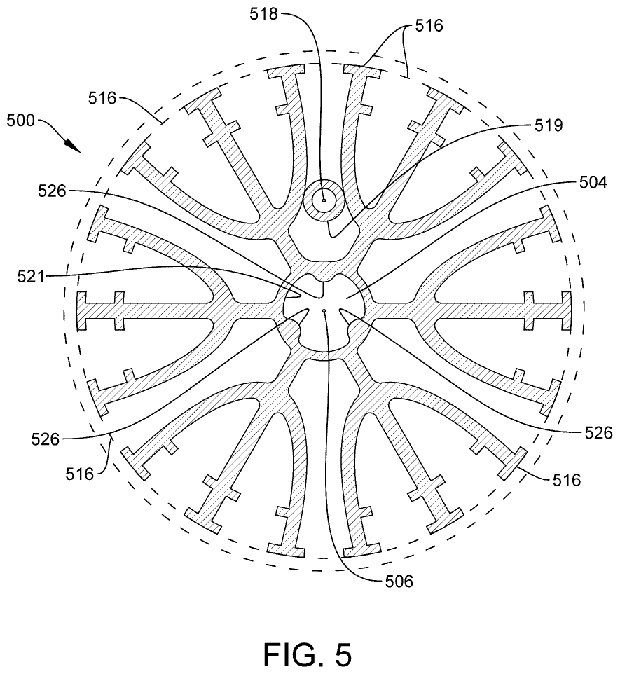

Turning now to FIG. 5, another embodiment of an insert 500 is shown. As can be seen in the insert 500 of FIG. 5, embodiments of the various inserts described herein need not have a thermocouple space 518 that is contiguous with the central void 504. In other words, a cross-sectional perimeter 519 of the thermocouple space 518 need not overlap a cross-sectional perimeter 521 of the central void. In this embodiment, the insert 500 may include a plurality of positioning nubs 526. However, in this embodiment, a portion of an exterior surface of a thermocouple (not shown) positioned within the thermocouple space 518 could not serve as a positioning nub because no part of a thermocouple positioned within the thermocouple space 518 could also occupy some of the central void 504. In one embodiment, the thermocouple space may be positioned closer to the cross-sectional center 506 of the insert than to a cross-sectional outer perimeter 516 of the insert. In other embodiments, the longitudinal thermocouple space 518 is positioned closer to a longitudinal outer perimeter 516 of the insert than to the longitudinal center 516 of the insert. It will be appreciated by those of skill in the art that a thermocouple space 518 configured to be too close to the perimeter 516 of the insert 500 may cause a thermocouple (not shown) inserted into the space 518 to measure a heat of reaction within a particular reaction zone that is influenced by factors outside of the insert. For example, a cooling jacket or system (not shown) that may surround a perimeter of, or enclosure to, the insert may cause the measurement of the heat of reaction in a reaction zone adjacent to the insert perimeter to be influenced by more than just the reaction itself.

It will be appreciated that the embodiments described herein can be said to have an offset thermocouple space relative to the center of the insert when a central axis of the thermocouple space is not colinear with a central axis of the insert or central void. Stated another way, the thermocouple space is offset relative to the central axis of the insert or central void because the cross-sections of thermocouple space and central void are not concentric. In this offset configuration, the central void, which is not required to concentrically hold a thermocouple of the insert can be empty of catalyst to reduce the heat of reaction delta across the insert when used within an FT reactor, while simultaneously allowing a thermocouple to measure the heat of reaction in a more desirable and effective place within the insert when the insert is used as part of an FT reactor. Thus, this configuration is an improvement because it facilitates better measurement, and consequently control of the heat of reaction across a reactor in which the insert is positioned.

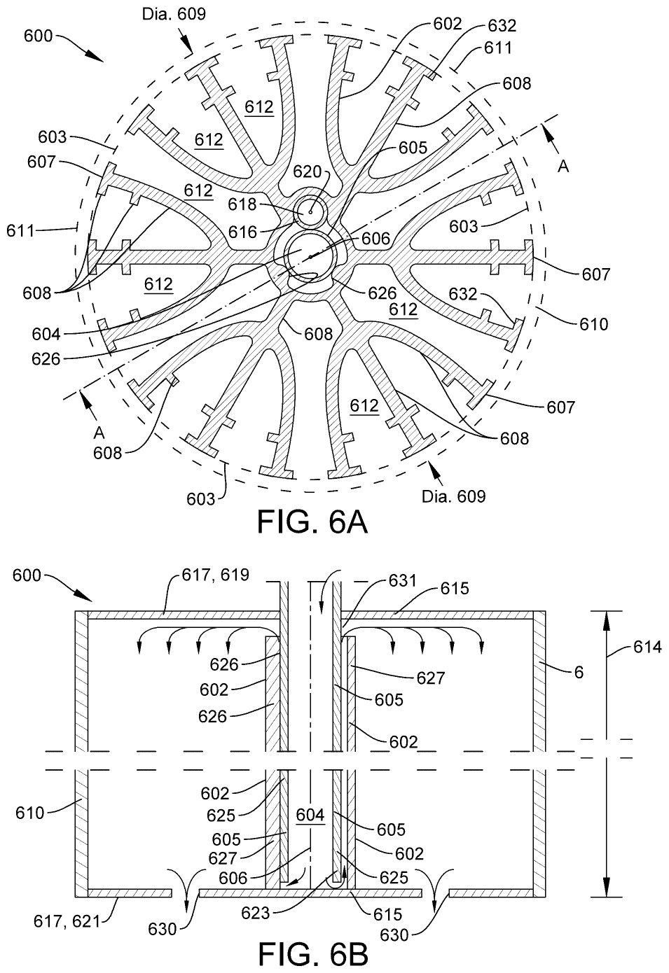

Turning now to FIG. 6, a Fischer Tropsch (FT) Reactor 600 is shown. The FT Reactor 600 may include an insert 602 having a fin structure. In one embodiment, the fin structure and the insert 602 are the one and the same. Hereinafter, the terms “insert” and “fin structure” may each be referenced as 602 and the terms may be used interchangeably to mean an insert having a fin structure or an insert that is a fin structure. The insert 602 may be configured to be positioned within a Fischer Tropsch (“FT”) reactor. The insert 602 may be one or more of the inserts described herein throughout or may have one or more characteristics of such inserts. The insert 602 is configured to transfer heat and be in contact with an interior surface 603 of the container 610.

In one embodiment, the reactor 600 includes a container 610. In one embodiment the insert 602 is configured to fit within the container 610. The container 610 may have any number of cross-sectional perimeter shapes and be configured to contain any number of cross-sectional insert 602 perimeter shapes (not shown). The container 610 in one embodiment may be substantially tubular and, in such configuration, may be referred to as a reactor tube 610. The container 610 may be configured to engage and be in contact with at least a portion of an exterior region 607 of the insert 602 when the insert 602 is positioned within the container 610. In one embodiment, the container 610 has an outside diameter 609 of greater than about 4 centimeters. In another embodiment, the outside diameter 609 is greater than about 8 centimeters. In one embodiment, the Nominal Pipe Size (NPS) may be 1, 1¼, 1½, 2, 2½, 3, 3½, 4, 5, 6, 8, 10, or 12. In one embodiment, a container thickness 611 may be greater than about 3.3 millimeters. In another embodiment, a container thickness 611 may be less than about 17.5 millimeters. In another embodiment, a container thickness 611 may be between about 3.8 millimeters and about 12.7 millimeters. In another embodiment, a container thickness 611 may be between about 5.4 millimeters and about 10.9 millimeters. In one embodiment, the container is a Schedule 5, 5S, 10, 10S, 20, 30, 40, 40S, 60, 68, 80S, 100, 120, 140, 160, STD, XS, XXS, XH, or XXH pipe according to the American schedule for pipes. The container 610 may include one or more metals or metal alloys including, without limitation, steel, stainless steel, galvanized steel, carbon steel, iron, nickel alloy, titanium alloy, carbon alloy, and the like. In one embodiment, the container size may be determined so as to meet a reactor 600 pressure need for a particular reactor 600 application.

In one embodiment, the insert 602 may be press fit into the container 610. In another embodiment the insert 602 may be affixed to the inner surface 603 of the container 610. In yet another embodiment, the insert 602 may be integral with the container 610. In one embodiment, the insert 602 is a heat transfer structure configured to be disposed at least partially within a container 610 to form part of a fixed bed Fischer Tropsch reactor 600.

The insert 602 may be configured to define a central longitudinal void 604 positioned at least partially along a central axis 606 of the insert 602. In certain embodiments the central longitudinal void 604 extends along a length 614 (see FIG. 6B) of the insert 602. The reactor 600 may include a tube 605 or bayonet 605 configured to fit within the central longitudinal void 604. The insert 602 may contain a plurality of positioning nubs 626 configured to facilitate the centering of the tube 605 or bayonet 605 within the longitudinal void 604.

In one embodiment, the reactor 600 may include a flow director 615 attached to one or more of the tubular container 610 and the heat transfer insert 602. The flow director may be adjacent at least one end of the one or more of the tubular container and the heat transfer insert. The flow director 615 may be configured to direct a gas feedstock into one or more of the catalytic reaction zones. In one embodiment, the flow director 615 may be one or more end caps 617 connected to one or more of the container 610 and the insert 602. In one embodiment, a first end cap 617, 619 is configured to receive a reactor 600 feedstock. In one embodiment, the end cap 617, 619 is configured to receive the bayonet 605, through which the reactor feedstock gas enters into the reactor 602. The flow directors 615 may facilitate an internal flow path through the internal void 604. In this configuration, the flow path allow the feedstock gas (not shown) to be preheated before the feedstock gas enters a reaction zone 612. The longitudinal void 604 also allows for a flow path within the void 604 to remove heat from central part of the reactor tube 610. Thus, embodiments described herein serve to control the heat of reaction which increases product production and efficient use of catalysts and other process resources. Having a central longitudinal void 604, that is free from catalyst and that can facilitate an internal flow path helps embodiments described herein regulate and normalize the heat of reaction across the reactor from a more central longitudinal area of the reactor tube 610 to an outer longitudinal area of the reactor tube 610.

In the embodiment described in FIG. 6B, the bayonet 605 is substantially centered within the longitudinal void 604 by the positioning nubs 626. In this embodiment, an annular passage is formed between an outer surface 625 of the bayonet 605 and an inner surface 627 of the longitudinal void 604. The reactor 602 is configured such that as the gas feedstock flows through the bayonet 605, the feedstock will exit a distal end 623 of the bayonet 605. The feedstock gas is then redirected by the flow director 615 up the annular passage. The feedstock gas leaves a distal end 631 of the annular passage where a flow director 615 directs the feedstock gas into one or more reaction zones 612. In one embodiment, an endcap 617, 621 is configured with one or more openings 630 configured to allow reactor product to exit the reactor 600. Thus, in this embodiment, the offset thermocouple space 618, where the thermocouple 616 does not occupy the central axis 606 of the reactor tube 610, allows the central longitudinal void 604 to be used as an internal flow path to better control the heat of reaction throughout the reactor 600.

In one embodiment, the fin structure 602 of the reactor 600 defines a thermocouple space 618 extending substantially along a length 614 (see FIG. 6B) of the fin structure 602. The reactor 600 may include a thermocouple 616. The thermocouple space 618 is configured to receive the thermocouple 616. As may best be seen in the reactor 600 cross-sectional view of FIG. 6A, the thermocouple space 618 may include a central longitudinal axis 620 that is not colinear with a central longitudinal axis 606 of the central void 604 that in some embodiments is also the central axis 606 of the fin structure 602. Accordingly, the thermocouple space 618 is offset from the longitudinal void 620. In one embodiment the thermocouple 616 has a has diameter between about 6 millimeters and about 7 millimeters.

It will be appreciated by those of skill in the art that in the embodiment depicted in FIGS. 6A and 6B, an outer surface of the thermocouple 616 positioned within the thermocouple space 618 serves as a positioning nub 626 for the bayonet 605 to help centered the bayonet 605 substantially at the center of the longitudinal space 604. In one embodiment, the outer wall of the thermocouple creates a substantially similar cross-sectional area to the cross-sectional area of the other positional nubs 626.

The insert 602 may include a plurality of fins 608 configured to define a plurality of catalytic reaction zones 612 along a length 614 (see FIG. 6B) of the insert 602 within the container 610. In one embodiment, the reactor 600 includes a catalyst material (not shown) and the reaction zones 612 are configured to receive at least a portion of a catalyst material (not shown). In one embodiment, the reactor 600 is configured such that the central longitudinal void 604 does not contain catalyst material (not shown). The insert 602 may operate to transfer heat from a heat source to a heat sink. In this embodiment, the heat source is the fixed bed catalytic reaction zones 612 and the heat sink may be the container 610, or a cooling system (not shown) adjacent to an outer surface 611 of the reactor container 610. The heat of reaction is removed from an interior area of the insert 602 along the path created by the fins 608 and out of the reactor 600 through the container.

To maintain the substantially even catalytic bed temperature, the insert 602 may be a high heat conductive metal finned extrusion. The extrusion would conduct heat from the reactor catalyst bed 612 to the reactor walls 610 and insure an improved temperature profile within the catalyst bed reaction zones 612. The improved heat removal ability derived by including the fins 608 within the catalyst bed also enables using much larger diameter reactors, thus reducing cost and increasing capacity. In one embodiment the insert 602 may have a variety of cross-sectional design. In one embodiment, the insert may have a snowflake design.

In the embodiment shown the fin 608 configuration may be configured so as to have dihedral symmetry. The fins may include a pad 632 at a point where the fin 608 engages an interior surface 603 of the container 610. The fins 608 may be in any number of configurations in order to remove heat from the reaction zones 612. In one embodiment the fins are configured to be efficiently extruded as described above. The fin inserts 602 and fin 608 configurations may be highly conductive metallic fin inserts for enhancing thermal management of a highly exothermic reaction Fischer Tropsch reaction. The fins 608 and fin insert serve as a thermal control for controlling product distribution and reactor 602 stability.

The reactor 600 may include catalysts (not shown). In one embodiment, the catalysts may be supported or unsupported. The catalyst may be configured in packed beds. In one embodiment the catalysts are arranged in packed beds defined by the fins 608. The catalysts may be those of the type and configuration used for Fischer Tropsch reactions. The catalysts may include one or more of alumina extrudates, silica pellets, self-supported iron and the like. In certain embodiments, micro-fiber catalysts may be used.

In one embodiment, an extruded aluminum (or other high heat conductive metal) fin insert is configured and placed within a tubular container 610 to optimize the output of a Fischer Tropsch (FT) reactor 600. The fin structure 602 may be configured with an insert fin configuration to facilitate an even temperature to maximize the production of the liquid (i.e., higher value) output from the FT reactor. The conduction of heat away from the center of the reactor catalyst bed will assist in maintaining an even temperature and allow control of the temperature within a desired range. The fin structure 602 may be configured with an offset thermocouple space 618 positioned within, or as part of, the insert 602 and consequently within or as part of the Fischer Tropsch reactor 600, such that the thermocouple measures a heat of reaction within the Fischer Tropsch reactor 600 at a predetermined position within the reactor 600. The determination of the thermocouple placement or position within the reactor 600 may be made given a number of factors, including heat analysis of the kind shown in FIG. 3. In one embodiment, the insert 602 may contain a plurality of thermocouple spaces 618 to allow for measurement of the heat of reaction within the reactor 600 at multiple places.

In one embodiment, the insert 602 of the reactor 600 is configured to optimize to maximize the reaction rate in the catalyst, or equivalently the heat generated by the reaction, without exceeding a prescribed maximum temperature. It will be appreciated by those of skill in the art, that the optimal maximization of the catalyst reaction rate and heat generated by the reaction, which is allowed for by embodiments described herein, serves as a way to maximize desired fuel production while preventing autothermal runaway.

In one embodiment, a Fischer Tropsch reactor 600 is configured to operate at a temperature T(r) between about 210° C. and about 235° C. where

$$T ( r ) = {T}_{w} + [ q \text{'''} {{r}_{w}}^{2} / 4 k ] [ 1 - {( r / {r}_{w} )}^{2} ]$$

and where T_{w} is the temperature at a wall of the tubular container, q′″ is a heat generation rate for a given catalyst material activity, r_{w} is the tubular container radius, k is an effective bed conductivity of a catalyst bed, and r is a radius within the substantially tubular container at which a reaction temperature is measured. In one embodiment, a temperature difference between an operational temperature at a wall of the substantially tubular container 610 and the approximate central axis 604 of the fin insert 602 is less than about 25° C.

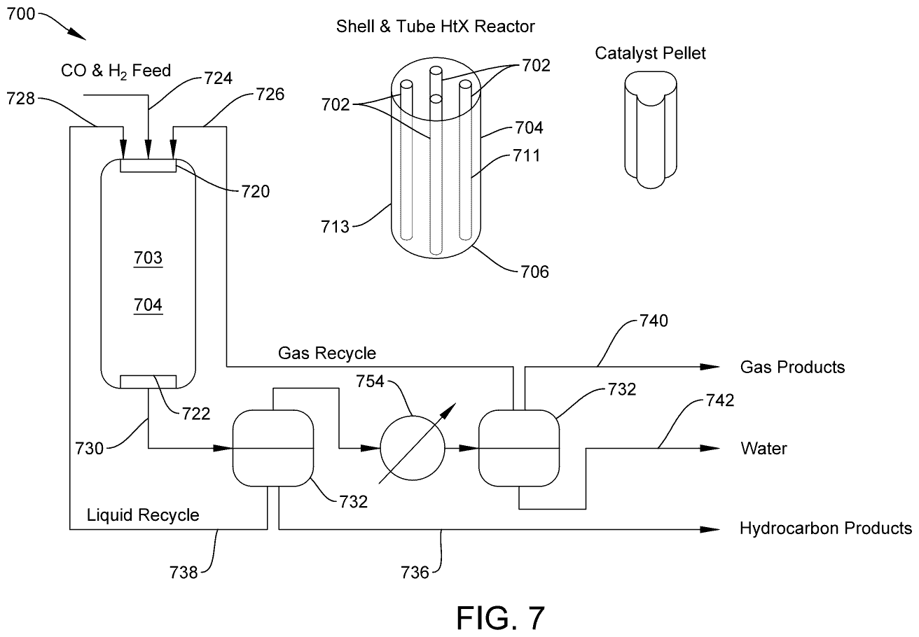

Turning now to FIG. 7, a reactor system 700 is shown. In one embodiment, the reactor system 700 includes at least one reactor 702. The reactor system 700 may include a plurality of reactors 702. One or more of the reactors 702 may be any of the reactors described herein throughout.

The reactor 702 may define a fixed catalyst bed containing a catalyst material. As discussed above, the reactor 702 may have an insert (not shown) that defines catalyst reactor zones (not shown) that may each include a portion of the catalyst material within the reactor 702. The insert may serve as a heat transfer device. As also discussed above, the insert may include a fin structure (not shown) that defines a central longitudinal void positioned at least partially along a central axis of the fin structure. The fin structure is configured to be in operation contact with an outer wall of the reactor 702 so the fin structure may facilitate the removal of heat from an interior of the reactor 702 to the exterior of the reactor 702.

The fin structure insert may define a central longitudinal void and a thermocouple space that are not colinear. One or more reactors 702 may include a thermocouple (not shown) for measuring the heat of reaction with the reactor 702. One or more reactors 702 may include a flow director configured to direct a gas feedstock along a flow path configured as least in part within the longitudinal void of the reactor 702. The flow path may be configured to remove a portion of the heat or reaction within the reactor 702. The flow director is also configured to facilitate the flow of feedstock gas into the reaction zones where it exothermically reacts with the catalyst material to create reaction heat. The longitudinal void does not contain catalyst material, which helps diminish the excessive buildup of reaction heat that often occurs in conventional reactors due to the concentration of the catalyst material in the center of those reactors. The reactor system 700 may have a reaction temperature monitor (not shown) that includes the thermocouple. Because the thermocouple is not positioned in the center of the reactor 702, the temperature monitor obtains a better representation of the heat of reaction across the reactor, which facilitates better heat control of the reaction temperature within the reactor 702.

In one embodiment, the reactor system 700 may include a plurality of reactors 702 that are grouped together to form a reactor bank 704 within the reactor system 700. The reactor bank 704 may have an enclosure 706 configured to allow operational communication between the reactors 702 and other components of the reactor system 700. This operational communication includes, without limitation, access to system feedstock inputs and product outputs, temperature monitors and controls, feedback controls, cooling and heating mechanisms, recycling mechanisms, other system controls and mechanisms, and the like. In one embodiment, the reactor system 700 may have one or more reactor banks 704. It will be appreciated that grouping reactors may capitalize on efficiencies within the system. Additionally, the reactor bank 704 configuration may facilitate easier maintenance and problem detection.

In one embodiment, the reactor system 700 may include a cooling apparatus (not shown) positioned adjacent an outer surface 711 of the reactor container 710 and/or an outer surface 713 of the reactor bank 706. In one embodiment, the cooling apparatus may be an external tube substantially surrounding the reactor 700 and/or the reactor bank 704 that may contain saturated steam to help control temperature. In another embodiment, the cooling apparatus may include a cooling block (not shown) adjacent the outside of the reactor container 710 and/or the outside of the reactor bank enclosure 706. The cooling block may contain heat removal media. In other embodiments, the cooling block may include cooling channels for receiving a cooling fluid (not shown). In one embodiment, the cooling fluid might include oil, liquid or some other fluid that can absorb and/or disburse heat. It will be appreciated by those of skill in the art that various cooling apparatus configurations may be used to serve this function.

The reactor system 700 may also include a heating apparatus (not shown) that at least partially surrounds the reactor container 710 and/or the reactor bank enclosure and is configured to create heat that may transfer from the outside of the reactor 702 and/or reactor bank 704 into the reactor 702 and/or reactor bank. In one embodiment heat produced by the heating apparatus may conduct through the heat transfer insert to increase the temperature of the catalytic material within the reaction zones of the reactor 702

In one embodiment, the reactor 702 and/or reactor bank 704 of the reactor system 700 includes a feedstock input 720 and reaction byproduct output 722. The input 720 may include one or more inputs for the feedstock gas 724 and one or more inputs for other feedstocks, such as, but not limited to, recycled gas 726 and recycled liquid 728. The feedstock gas input 724 may be operationally connected to the flow path (not shown) within the longitudinal void created by the insertion of a bayonet within the longitudinal void, as discussed in connection with FIGS. 6A and 6B above. Thus, the feedstock gas and other desired inputs may be directed into the catalyst zones of the reactors 702. Reaction products 730 may exit the reaction byproduct output 722 of the one or more a reactors 702 and/or reactor banks 704.

The reactor system 700 may include other elements such as separators, recyclers, flow regulators, pressure regulators, temperature gauges, pressure gauges, and other such elements known to be used in fluid flow systems. In one embodiment, one or more separators 732 are configured to separate and capture various elements of the product output 730. In one embodiment, a separator 732 may separate hydrocarbon products 736 and liquid 738. Some or all of the hydrocarbon products 736 may be collected and some or all of the liquid 738 may be recycled back through the recycled liquid input 728 and become part of the feedstock input 720. In one embodiment, a separator 732 may separate out gas products 740 and water 742 from the product output 730. In one embodiment, some of the gas products 740 may be recycled back through the recycled gas input 728 and become part of the feedstock input 720. The water 742 may also be collected.

It will be appreciated that the fluid flow and separators may be configured in a variety of ways. Some of the reactor system elements may be positioned in parallel or in sequence. Various gauges and regulators may also be positioned within the reactor system 700 in variety of ways to accomplish the teachings of embodiments of the invention. In other embodiments, the reactor system 700 may include a pressure source configured to supply varying amounts of pressure to one or more of the feedstock components. One or more to the feedstock inputs 724, 726, 728 may include valves to control the amount of the one or more feedstock inputs 724, 726, 728 that enters into the one or more reactors 702 or reactor banks 704.

The reactor system 700 may include a temperature control system (not shown) in operable communication with the reaction temperature monitor such that a heat of reaction within a reactor 702 may be measured by the thermocouple of the temperature monitor and the temperature may be sent to the temperature control system. The temperature control system is configured to regulate the temperature or heat of reaction based on temperature readings from one or more thermocouples strategically placed within one or more reactors 702 based on the configuration of the fin inserts (not shown) within each reactor 702. In one embodiment, the temperature control system is in operational communication with elements of the reactor system 700 that elements that can directly or indirectly regulate the heat or temperature of reaction within the reactors 702 and/or reactor banks 704. These elements may include, without limitation, pressure sources and regulators, cooling systems, heating systems, separators, recyclers, feedstock inputs 720, byproduct outputs 722, valves and other fluid flow regulators configured to control the amounts, concentrations, flow rates, and other characteristics of the feedstocks into the reactors 702 and/or reactor banks 704, and the like.

In one embodiment, the temperature control system helps a temperature of reaction T(r) range between about 210° C. and about 235° C. The temperature control system may help keep an operational temperature T(r) at a container wall of the reactor 702 within less than about 25° C. of an operational temperature T(r) at the approximate central axis of the reactor's 702 fin insert. In one embodiment, the temperature control system may facilitate keeping the operational temperature and/or the heat of reaction within the reactor 702 by facilitating the control of the variables in the following reaction:

$$T ( r ) = {T}_{w} + [ q \text{'''} {{r}_{w}}^{2} / 4 k ] [ 1 - {( r / {r}_{w} )}^{2} ] \qquad ( 1 )$$

where T_{w} is the temperature at a wall of the reactor, q′″ is a heat generation rate for a given catalyst material activity, r_{w} is the tubular container radius, k is an effective bed conductivity of a catalyst bed, and r is a radius within the substantially tubular container at which a reaction temperature is measured by virtue of the thermocouple position within the insert of the reactor 702. It will be appreciated that if the thermocouple is positioned to close to the center of the reactor, it may measure the syngas temperature and not the reaction temperature. Additionally, if the thermocouple is positioned too close to the outer wall, its measuring of the reaction rate may be undesirably affected by a cooling system close to the outer wall. In one embodiment, the fin insert is configured such that the thermocouple is placed to within the reactor 702 to maintain the desired heat of reaction T(r) within an acceptable range.

In one embodiment, the reactor system 700 is configured such that the operational heat or heat of reaction is measured by a thermocouple that is not colinear with the centerline of the fin insert.

In one embodiment, the temperature control system may control the intake of fresh feedstock 724 and recycled feedstock 726 and/or liquid 728. The temperature control system may, in combination with various system elements, reduce or cut off the intake of fresh feedstock 724 to starve the catalytic reaction within the reactor 702, thus reducing the operational temperature. The temperature control system may facilitate the lowering of the amount of carbon monoxide (CO) and/or hydrogen H₂ reactants to slow the reaction rate and thus reduce the temperature. The temperature control system may control the flow rates in the reactor system 700 to cool the operational temperature. The temperature control system may control the reaction temperature by reducing or increasing the amount of pressure applied to various inputs 724, 726, 728 or the pressure driving the reaction rate to thus affect the reaction temperature. In other embodiments, the temperature control system may utilize the heating system to increase the operational temperature within the reactor 702. In other embodiments, the temperature control system may interact with the cooling system by adjusting flow rates within the cooling system or by adjusting the cooling jacket temperature.

It will be appreciated by those of skill in the art that if the operational temperature or heat of reaction increases to undesired levels, the temperature control system may use one or more of the temperature control methods described herein, either alone or in combination to control the operational temperature of the reactors 702 or reactor bank 704. The temperature control system may also use other means known in the art to modify the reaction rate and thus modify the heat of reaction.

In one embodiment, the temperature adjustment may be done manually. In another embodiment, one or more factors that affect or control temperature are adjusted automatically based on a temperature measurement.

In one embodiment, the reactor system 700 is a Fischer Tropsch reactor system.

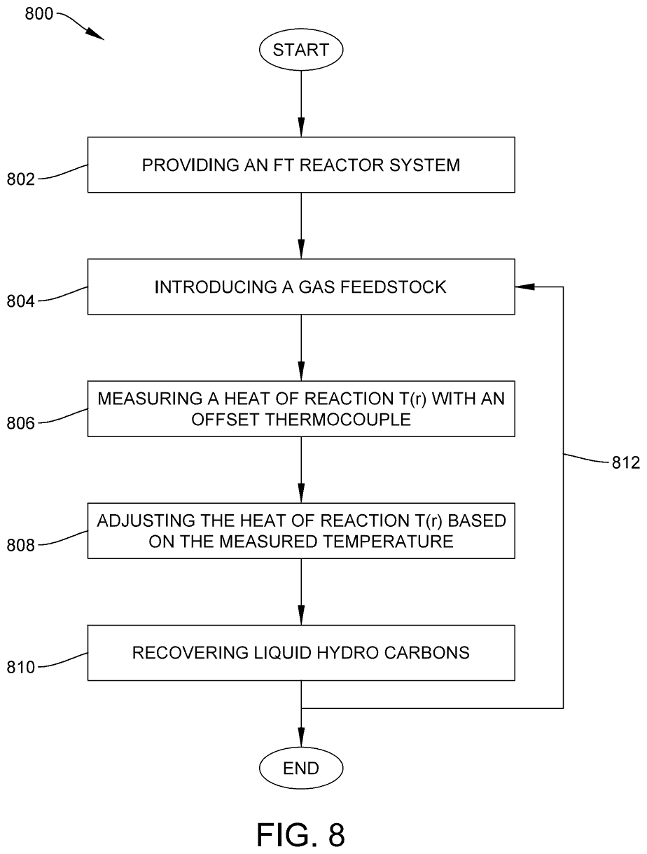

Turning now to FIG. 8, an embodiment of a method 800 of converting a gas feedstock into liquid hydrocarbons using a Fischer Tropsch system is shown. The method includes providing a Fischer Tropsch reactor or system 802. The Fischer Tropsch reactor or system may be any of the reactors or systems described herein. In one embodiment, The Fischer Tropsch Reactor System includes at least one reactor that includes a heat transfer insert configured to define catalyst reaction zones containing a catalyst. The heat transfer insert is configured to transfer heat from an interior of the reactor to an exterior of the reactor. The insert may be configured to contain a thermocouple and central longitudinal void at a central axis of the reactor such that an axis of the thermocouple may be parallel to the central axis of the reaction, but not colinear with it. In other words, the thermocouple is offset from the center of the reactor. The Fischer Tropsch reactor system may include temperature monitors and control systems to monitor the heat and regulate it to within a desired temperature range to maximize desired liquid hydrocarbon output.

The method 800 may contain the step of introducing 804 a gas feedstock into one or more of the catalyst zones in one or more of the reactors. In one embodiment, introducing 804 a gas feedstock may include introducing one or more of a fresh gas feedstock, a recycled gas, carbon monoxide gas feedstock, and a hydrogen gas feedstock. As will be discussed in more detail below, the step of introducing a gas feedstock 804 may include introducing the gas feedstock at varying flow rates, at varying pressure rates, with varying concentrations of gas feedstock constituents, and the like. In one embodiment, the step of introducing 804 the gas feedstock includes preheating the gas feedstock prior to prior to introducing 804 the gas feedstock into one or more of the catalyst zones. In one embodiment the gas feedstock may be preheated by flowing the gas feedstock within the central longitudinal void that extends by the exothermically reacting catalyst. In this configuration, the center of the catalyst zones may be cooled by heating the gas.

The method 800 may include measuring 806 the heat of a catalyst zone with a thermocouple that is not colinear with the centerline of the insert. It will be appreciated that with the thermocouple “offset” from the centerline or central axis of the insert, and consequently the reactor, the measuring 806 of the heat of reaction is more accurate because the thermocouple is less influenced by the temperature of the syngas.

The method may include adjusting 808 the heat of reaction T(r) based on the measured temperature. In one embodiment, a pressure driving the reaction rate is adjusted, which in turn adjusts 808 the reaction rate and thus the reaction temperature. The reaction rate, and thus the reaction temperature, may also be adjusted 808 by modifying the amount of one or more of carbon monoxide and hydrogen in the gas feedstock. The reaction rate may be adjusted 808 adding less fresh feedstock input and instead adding more recycled input to lower the amount of CO and Hydrogen reactants, which slow the reaction rate and thus the reaction temperature. In one embodiment, adjusting 808 the catalyst reaction temperature includes modifying a flow rate of the gas feedstock. In another embodiment, where the FT system includes a cooling jacket, adjusting 808 the reaction temperature based on the measured temperature comprises adjusting the temperature of the cooling jacket. This might be done by adjusting the rate at which cooling jacket fluid is recycled.

Adjusting 808 the catalyst reaction temperature may include cooling one or more of the catalyst zones. In one embodiment, adjusting 808 the reaction temperature may include providing a feedstock gas or reforming gas into the interior of Fischer Tropsch reactor of the type described herein. The gas may be introduced into a first end of a bayonet positioned in a central void of the Fischer Tropsch reactor. The gas may then exit a second end of the bayonet and into an anulus formed by the outer surface of the bayonet and an inner surface of the central void. The gas is then directed into one or more catalyst beds in the Fischer Tropsch reactor. In this embodiment, the center of the reactor is cooled as heat is removed from the reaction by the moving gas through the center of the reactor. This provides a cooling mechanism for cooling a longitudinal center of the reactor. Additionally, this embodiment allows feedstock gas such as syngas to be preheated before entering the catalyst beds of the reactor.

Another way to control and/or adjust 808 the temperature of reaction is to design or configure the fin insert such that the catalyst and/or catalyst beds are moved out from a central axis of the Fischer Tropsch reactor. In one embodiment, the catalyst of the reactor is positioned a length away from the central axis of the reactor that is greater than a cross-sectional outer diameter of a tubular thermocouple of the reactor. Accordingly, embodiments disclosed herein have catalyst beds that are further away from the central axis of the reactor than they would otherwise be if the catalyst were to be in contact with a thermocouple position along the central axis.

In one embodiment, adjusting 808 the temperature of reaction T(r) is done manually by manually adjusting 808 one or more of the factors that affect the reaction rate, cooling mechanisms, or other temperature variables. In another embodiment, the temperature of reaction T(r) is adjusted 808 automatically by automatically adjusting one or more of the factors that affect the reaction rate, cooling mechanisms, or other temperature variables.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of embodiments encompassed by the disclosure as contemplated by the inventors.

The scope of the present invention is defined by the appended claims.

What is claimed is:

1. A heat transfer insert, comprising:
a fin structure configured to fit within a substantially tubular container;
wherein the fin structure defines a central longitudinal void positioned at least partially along a central axis of the fin structure;
wherein the fin structure comprises a plurality of fins extending outwardly from the central longitudinal void, the plurality of fins configured to define a plurality of catalytic reaction zones along a length of the fin structure, the plurality of fins configured to transfer heat from an interior of the fin structure to an exterior of the fin structure; and
wherein the fin structure defines a thermocouple space extending substantially along the length of the fin structure, wherein the thermocouple space is configured to receive a thermocouple, and wherein a central axis of the thermocouple space is not colinear with the central axis of the fin structure.

2. The heat transfer insert of claim 1, wherein the thermocouple space is at least partially contiguous with the central void.

3. The heat transfer insert of claim 1, wherein the thermocouple space is not contiguous with the central void.

4. The heat transfer insert of claim 1, wherein the central longitudinal void is substantially columnar and is defined by a substantially circular cross-sectional portion of the fin structure, the substantially circular cross-section portion of the fin structure extending longitudinally along the central axis of the fin structure.

5. The heat transfer insert of claim 4, wherein the fin structure comprises at least one positioning nub extending inwardly from the substantially circular cross-sectional portion of the fin structure into the central longitudinal void.

6. The heat transfer insert of claim 5, wherein the fin structure comprises a plurality of primary fins having a first end connected to the substantially circular cross-sectional portion of the fin structure and a second end extending outwardly away from the substantially circular cross-sectional portion of the fin structure, wherein the second end of said plurality of primary fins is configured to contact an interior surface of the substantially tubular container.

7. The heat transfer insert of claim 6, wherein a cross-sectional thickness of at least one of the primary fins is substantially uniform between the first and second ends of said primary fin.

8. A Fischer Tropsch reactor comprising:
a substantially tubular container;
a catalyst material;
a heat transfer insert configured to fit within the tubular container and be in contact with an interior surface of the tubular container, wherein the heat transfer insert comprises,
a fin structure defining a central longitudinal void positioned at least partially along a central axis of the fin structure, wherein the fin structure comprises a plurality of fins extending outwardly from the central longitudinal void, the plurality of fins configured to define a plurality of catalytic reaction zones along a length of the fin structure, the catalytic reaction zones configured to receive at least a portion of the catalyst material, and wherein the central longitudinal void does not contain the catalyst material;
wherein the fin structure defines a thermocouple space extending substantially along the length of the fin structure, wherein the thermocouple space is configured to receive a thermocouple, and wherein a central axis of the thermocouple space is not colinear with the central axis of the fin structure; and
a flow director attached to one or more of the tubular container and the heat transfer insert adjacent at least one end of the one or more of the tubular container and the heat transfer insert, the flow director configured to direct a gas feedstock into one or more of the catalytic reaction zones.

9. The Fischer Tropsch reactor of claim 8, further comprising a bayonet positioned within the central longitudinal void.

10. The Fischer Tropsch reactor of claim 9, further comprising a plurality of positioning nubs extending into the central longitudinal void, the positioning nubs configured to substantially center the bayonet within the central longitudinal void.

11. The Fischer Tropsch reactor of claim 10, wherein the bayonet is configured and positioned within the central longitudinal void such that the bayonet forms a fluid flow path along an interior surface of the bayonet, and an annular flow path between an exterior surface of the bayonet and the portion of the structure defining the central longitudinal void, the annular flow path and fluid flow path being configured to be in fluid communication with each other.

12. The Fischer Tropsch reactor of claim 10, further comprising a thermocouple positioned within the thermocouple space, wherein at least one positioning nub comprises a portion of the thermocouple.

13. A Fischer Tropsch system comprising:
at least one Fischer Tropsch reactor, the Fischer Tropsch reactor comprising:
a substantially tubular container;
a catalyst material;
a heat transfer insert configured to fit within the tubular container and be in contact with an interior surface of the tubular container, wherein the heat transfer insert comprises,
a fin structure defining a central longitudinal void positioned at least partially along a central axis of the fin structure, wherein the fin structure comprises a plurality of fins extending outwardly from the central longitudinal void, the plurality of fins configured to define a plurality of catalytic reaction zones along a length of the fin structure, the catalytic reaction zones configured to receive at least a portion of the catalyst material, and wherein the central longitudinal void does not contain the catalyst material;
wherein the fin structure defines a thermocouple space extending substantially along the length of the fin structure, wherein the thermocouple space is configured to receive a thermocouple, and wherein a central axis of the thermocouple space is not colinear with the central axis of the fin structure;
a flow director attached to one or more of the tubular container and the heat transfer insert adjacent at least one end of the one or more of the tubular container and the heat transfer insert, the flow director configured to direct a gas feedstock into one or more of the catalytic reaction zones;
a reaction temperature monitor comprising a thermocouple positioned within the thermocouple space; and
a temperature control system in operable communication with the reaction temperature monitor.

14. The system of claim 13, further comprising a catalyst bed comprising at least one catalyst reaction zone, wherein at least one the Fischer Tropsch reactor is configured to operate at a temperature T(r) between about 210° C. and about 235° C. where
T(r)=T_{w}+[q′″r_{w}²/4 k][1−(r/r_{w})²], and where T_{w} is the temperature at a wall of the tubular container, q′″ is a heat generation rate for a given catalyst material activity, r_{w} is the tubular container radius, k is an effective bed conductivity of a catalyst bed, and r is a radius within the substantially tubular container at which a reaction temperature is measured.

15. The system of claim 13, wherein the temperature difference between an operational temperature at a wall of the substantially tubular container and the approximate central axis of the fin insert is less than about 25° C.

16. A method of converting a gas feedstock into liquid hydrocarbons using a Fischer Tropsch system, the method comprising:
providing a Fischer Tropsch system comprising:
at least one Fischer Tropsch reactor, the fisher Tropsch reactor comprising:
a substantially tubular container;
a catalyst material;
a heat transfer insert configured to fit within the tubular container and be in contact with an interior surface of the tubular container, wherein the heat transfer insert comprises,
a fin structure defining a central longitudinal void positioned at least partially along a central axis of the fin structure, wherein the fin structure comprises a plurality of fins extending outwardly from the central longitudinal void, the plurality of fins configured to define a plurality of catalytic reaction zones along a length of the fin structure, the catalytic reaction zones configured to receive at least a portion of the catalyst material, and wherein the central longitudinal void does not contain the catalyst material;
wherein the fin structure defines a thermocouple space extending substantially along the length of the fin structure, wherein the thermocouple space is configured to receive a thermocouple, and wherein a central axis of the thermocouple space is not colinear with the central axis of the fin structure;
a flow director attached to one or more of the tubular container and the heat transfer insert adjacent at least one end of the one or more of the tubular container and the heat transfer insert, the flow director configured to direct a gas feedstock into one or more of the catalytic reaction zones;
a reaction temperature monitor comprising a thermocouple positioned within the thermocouple space; and
a temperature control system in operable communication with the reaction temperature monitor;
introducing a gas feedstock into one or more of the catalyst zones;
measuring the heat of a catalyst zone with a thermocouple that is not colinear with the centerline of the insert; and
adjusting a catalyst reaction temperature based on the measured temperature.

17. The method of claim 16, further comprising preheating the gas feedstock by flowing the gas feedstock by the exothermically reacting catalyst prior to introducing the gas feedstock into one or more of the catalyst zones.

18. The method of claim 16, wherein adjusting the catalyst reaction temperature comprises modifying the amount of one or more of carbon monoxide and hydrogen in the gas feedstock.

19. The method of claim 16, wherein adjusting the reaction temperature comprises modifying a flow rate of the gas feedstock.

20. The method of claim 16, wherein the FT system further comprises a cooling jacket, and wherein adjusting the reaction temperature based on the measured temperature comprises adjusting the temperature of the cooling jacket.
